(19) United States
(12) Patent Application Publication
(10) Pub. No.: US 2012/0043031 A1
(43) Pub. Date: Feb. 23, 2012

(54) DOOR PANEL

(75) Inventor: Jay Philip Leighton, Charlotte, NC (US)

(73) Assignee: FORBO SIEGLING, LLC, Huntersville, NC (US)

(21) Appl. No.: 13/211,930

(22) Filed: Aug. 17, 2011

Related U.S. Application Data
(60) Provisional application No. 61/374,477, filed on Aug. 17, 2010.

(51) Int. Cl. E06B 9/68; E06B 9/171; E06B 9/02

(52) U.S. Cl. 160/270; 160/405

(57) ABSTRACT

A door panel comprises a fabric carcass, including a first fabric layer having an inner surface and an outer surface, a second fabric layer having an inner surface and an outer surface, and a composition comprising polyurethane, the composition disposed between the inner surface of the first fabric layer and the inner surface of the second fabric layer for joining the first fabric layer and the second fabric layer. A first foam polymeric layer has an inner surface adhered to the outer surface of the first fabric layer such that an outer surface of the first foam polymeric layer at least partially forms an outer surface of the door panel. A second foam polymeric layer has an inner surface adhered to the outer surface of the second fabric layer such that an outer surface of the second foam polymeric layer at least partially forms an inner surface of the door panel.

### CROSS-REFERENCES

This application is related to U.S. provisional application No. 61/374,477, filed Aug. 17, 2010, entitled “Door Panel”, naming Jay Leighton as the inventor. The contents of the provisional application are incorporated herein by reference in their entirety, and the benefit of the filing date of the provisional application is hereby claimed for all purposes that are legally served by such claim for the benefit of the filing date.

### BACKGROUND

This invention relates generally to a door panel, and more particularly to an insulated door panel for use with a roll-up door, which moves between a vertical position for closing a door opening to a rolled-up position adjacent the top of the door opening.

Many industrial and retail buildings will typically have doorways or rooms that must be opened and closed frequently for ingress and egress of personnel and material. This presents a particular problem for climate-controlled rooms, such as commercial refrigerators, freezer rooms, and the like. In some cases the open doorway and the rooms may be quite large, making it extremely difficult to control the interior temperature within the room or building.

High speed roll-up doors provide a barrier across a door opening, a room or other space and function to control access through the door opening. Conventional roll-up doors consist of a solid flexible curtain or panel, typically made of plastic, vinyl, fabric or the like. The door is mounted so that the panel may be moved by electromechanical drive means between a vertical rolled down, or closed position, and a rolled up or open position. A pair of opposed track members positioned on either side of the opening support the door panel. A transverse shaft or roller on to which the flexible panel is rolled into a coil is supported above the door opening. Electromechanical or manual means are provided for driving the shaft.

Insulated roll-up doors may be used as an external closure for closing openings in climate-controlled rooms. The insulation effect developed by the door corresponds essentially to the insulation effect of the external walls of the climate-controlled room, so that when the door is in the closed position there exists a uniformly insulated room, in which goods to be cooled such as, for example, foodstuffs, can be stored. However, roll-up doors typically have insufficient thermal insulation due to the poor insulation properties of the material of the door panel. Attempts to minimize heat transfer include filling the interior space between the inner and outer surfaces of the door panel with insulation.

Insulated door panels continue to suffer from heat transfer problems, leading to condensation. Warm surrounding air meets the door panel and there, due to the temperature difference, condenses on the surface. This can result in a significant accumulation of moisture or to the formation of ice on the door panel and the floor area under the door. The function of the door panel can be significantly impaired, the ice formation resulting in the door no longer being easily rolled up. Formation of ice on the floor area under the roll-up door represents an obstacle and a hazard when entering the climate-controlled room. In order to maintain the function of the roll-up door, supplementary heat is frequently provided in the track members and to the door panel surface so that they remain free of ice. Ice formation under the roll-up door is eliminated by floor heating. However, this approach requires significant additional energy be added to the operation of the climate-controlled room.

For the foregoing reasons, there is a need for an improved insulated door panel for use in a roll-up door. Ideally, the new door panel will restrict loss of energy from heated or cooled rooms and minimize condensation around the exterior of the door.

### SUMMARY

A door panel is described, the door panel comprising a fabric carcass, including a first fabric layer having an inner surface and an outer surface, a second fabric layer having an inner surface and an outer surface, and a composition comprising polyurethane, the composition disposed between the inner surface of the first fabric layer and the inner surface of the second fabric layer for joining the first fabric layer and the second fabric layer. A first foam polymeric layer having an inner surface and an outer surface is provided, the inner surface of the first foam polymeric layer adhered to the outer surface of the first fabric layer such that the outer surface of the first foam polymeric layer at least partially forms an outer surface of the door panel. A second foam polymeric layer having an inner surface and an outer surface is provided, the inner surface of the second foam polymeric layer adhered to the outer surface of the second fabric layer such that the outer surface of the second foam polymeric layer at least partially forms an inner surface of the door panel.

A door is provided for mounting across an opening in a building wall. The door comprises a shaft adapted to be rotatably mounted to the wall substantially horizontally above door opening. A door panel comprises a fabric carcass, including a first fabric layer having an inner surface and an outer surface, a second fabric layer having an inner surface and an outer surface, and a composition comprising polyurethane, the composition disposed between the inner surface of the first fabric layer and the inner surface of the second fabric layer for joining the first fabric layer and the second fabric layer. A first foam polymeric layer has an inner surface and an outer surface. The inner surface of the first foam polymeric layer is adhered to the outer surface of the first fabric layer such that the outer surface of the first foam polymeric layer at least partially forms an outer surface of the door panel. A second foam polymeric layer has an inner surface and an outer surface. The inner surface of the second foam polymeric layer is adhered to the outer surface of the second fabric layer such that the outer surface of the second foam polymeric layer at least partially forms an inner surface of the door panel. Opposed track members are adapted to be mounted to the wall adjacent the door opening for slidably receiving the side edges of the door panel. Rotation of the shaft in one direction moves the door panel from a coiled condition in an open position to a closed position, and rotation of the shaft in the other direction winds the door panel around the shaft to the coiled condition for moving the door panel from the closed position to an open position.

### BRIEF DESCRIPTION OF THE DRAWINGS

For a more complete understanding of the present invention, reference should now be had to the embodiments shown in the accompanying drawings and described below. In the drawings:

FIG. 1 is shown a fragmentary, perspective view of an insulated building structure having a flexible door panel on a track.

FIG. 2 is a schematic, elevational, partial view of a longitudinally extending portion of a portion of a door panel according to an embodiment.

### DESCRIPTION

Certain terminology is used herein for convenience only and is not to be taken as a limitation on the invention. For example, words such as “upper,” “lower,” “left,” “right,” “horizontal,” “vertical,” “upward,” and “downward” merely describe the configuration shown in the FIGs. Indeed, the components may be oriented in any direction and the terminology, therefore, should be understood as encompassing such variations unless specified otherwise.

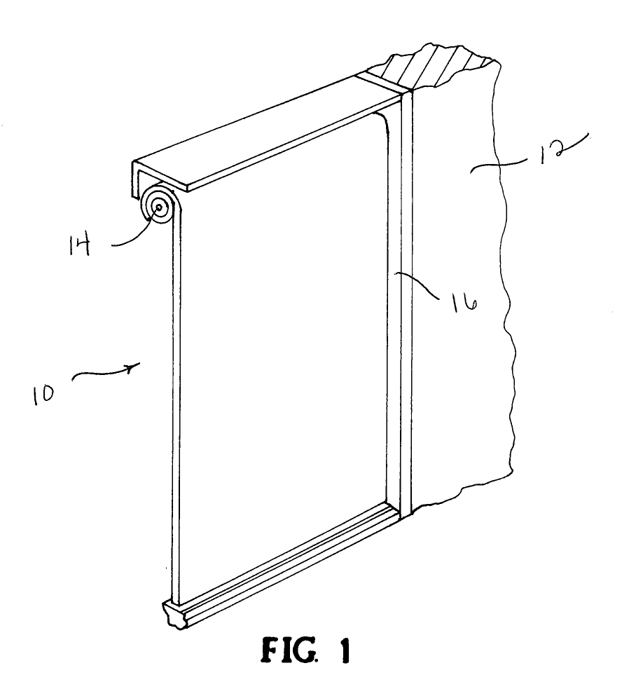

Referring now to the drawings, wherein like reference numerals designate corresponding or similar elements throughout the several views, a roll-up door is shown in FIG. 1, including an embodiment of a door panel generally designated at 10. The door panel 10 is mounted across a door opening in a building wall 12 to create a barrier through which personnel and material may pass. The door panel 10 comprises an insulated door panel suspended from a supporting roller or shaft 14 mounted substantially horizontally above the door opening. The sides of the door panel 10 are slidably mounted in a pair of opposed vertical track members 16 positioned at either side of the door opening, only one of which is shown in FIG. 1. The door panel 10 is adapted to span the door opening and provide an air-blocking seal across the opening between the track members 16. It is understood that the door panel 10 will be described in connection with the door opening generally depicted, although it will be appreciated that the door panel may also be utilized to create a barrier which partitions a room or other space.

The door panel 10 is a longitudinally flexible panel structure capable of being unrolled and rolled for extension and retraction from a coiled condition to cover and uncover the door opening so as to control the flow of thermal energy through the opening. Accordingly, the shaft 14 is rotatably mounted so that the rotation of the shaft in one direction moves the door panel 10 from a closed position, illustrated in FIG. 1, to an open position by winding the door panel 10 about the shaft 14 and causing the door panel to elevate to the open position wherein the door opening is unobstructed. Reverse rotation of the shaft 14 causes the door panel 10 to unwind and form an air-blocking seal adapted to prevent or minimize the passage of air across the door opening in the closed position. The shaft 14 may be driven by an electric motor (not shown) adapted to rotate the supporting shaft 14 so as to control the winding and unwinding of the door panel 10. It is appreciated that the shaft 14 may also be manually operated using a conventional chain, rope or cable system (not shown) or the like. The details of the shaft 14, track members 16, and motor need not be discussed in detail, it being noted that these features are well known in the art. However, it should be readily appreciated that the structure of the door panel 10 as described herein allows one to use these heretofore known components for an insulated roll-up door without requiring any adaptations to the track members, shaft and associated parts.

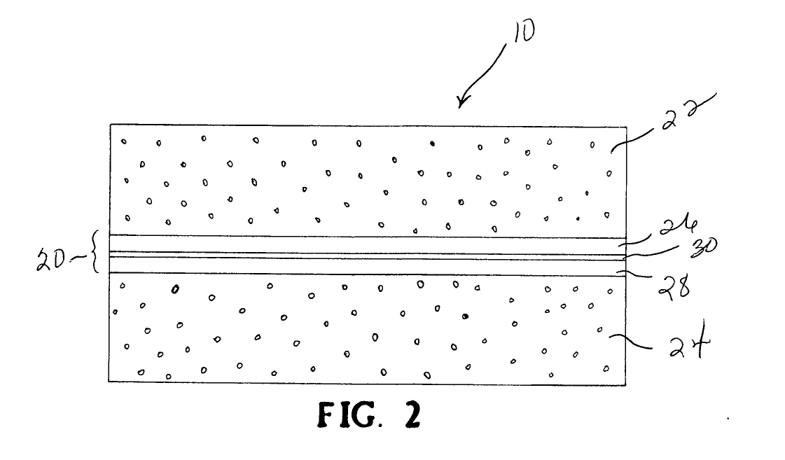

The door panel is constructed as shown in FIG. 2. The door panel comprises an inner fabric carcass 20 bounded by a first expanded foamed external layer 22 and a second expanded foamed external layer 24 of polymeric coating on either side of the carcass.

The inner fabric carcass 20 comprises a first ply of a woven polyester fabric 26 and a second ply of a woven polyester fabric 28. Each ply of polyester fabric 26, 28 is a plain weave, comprising a multifilament polyester warp yarn of about 500 to about 2000 denier, and preferably about 1000 denier. Thirteen warp yarns are provided per centimeter of width (33 yarns/inch of width). This arrangement provides for longitudinal flexibility, which yields a flexible door panel 10 for rolling. A monofilament polyester weft yarn is provided of about 0.3 mm to about 0.5 mm in diameter, and preferably about 0.4 mm. Nine weft yarns are provided per centimeter of length (23 yarns/inch of length). The monofilament weft yarns yield lateral stiffness of the door panel 10 in a direction parallel to the axis of rolling. Lateral stiffness helps the door panel 10 withstand wind, air pressure differentials between opposite sides of the door panel, and other forces acting on the door panel. The inner fabric carcass 20 serves as a barrier for preventing any cutting. The fabric carcass 20 also acts as a strengthening member, providing resistance against stretching, tearing and puncturing. Fabric weight is approximately 416 grams per square meter. A polyurethane elastomer intermediate layer 30 of approximately 0.02″ to 0.08″ thickness binds and separates the two fabric plies 26, 28. The design of the fabric carcass 20 provides resistance against bending around the vertical axis of the door panel 10, yet is flexible in the perpendicular direction so that the door panel 10 can be rolled up easily.

The outer expanded foamed polymeric layers 22, 24 are generally a coating of a flexible, resilient expanded foamed polymeric heat insulating material such as a flexible PVC. The flexible PVC is foamed in place using a chemical blowing agent. Each of the foam layers 22, 24 is approximately 0.40 inches to about 0.45 inches on both sides of the fabric carcass 20, yielding a total foam layer thickness of about 0.80 inches to about 0.90 inches. The fabric carcass 20 interconnects the two layers of foamed insulating material 22, 24 with the fabric densities allowing paste to pass through the fabric. The expanded foam PVC coating provides a high degree of thermal insulation, giving an R-value of at least 3.0, and provides good flexibility at low temperatures. The foam coating is also tough enough to resist damage from contact by people, goods, and equipment that might come in contact with the door panel 10 when used in an intended application.

The insulating material is foamed onto the fabric carcass 20 utilizing conventional insulation foaming techniques well known to those skilled in the art and allowed to cure. In one embodiment, a layer of fabric is first coated with foamable flexible PVC plastisol using a knife coater, but other coating techniques might be used. The PVC coating is then subjected to heat, which both cures the coating and activates the chemical blowing agent to expand and foam the coating. Two pieces of the foam-coated fabric are then laminated together with the fabric sides facing inward, and the PVC foam layers facing outward. For the lamination step, an extrusion-calendaring system and thermoplastic polyurethane elastomer are used, but other equipment, techniques, and materials could be used. For example, this step can also be done by sheet extrusion. Subsequently, the door panel material may need to be longitudinally seamed in order to make a door panel wide enough for an intended application. The door panel material is cut to the appropriate size and otherwise fabricated to a suitable panel to be assembled into the high-speed roll-up door.

A PVC plastisol for use in an embodiment of the door panel has a Brookfield viscosity @ 2.5 rpm of 55,000 to 75,000 centipoise, and a Brookfield viscosity @ 20 rpm of 20,000 to 29,000 centipoise. Percent foam achieved by heating at 180° C. for 7 minutes is about 83% to 87%. The PVC plastisol remains flexible at low temperature, down to −40° C. (−40° F.). A suitable PVC plastisol is available from Rutland Plastics Technologies, Pineville, N.C. The foamable PVC plastisol coating contains blowing agent chemical AZODICARBONAMIDE. Activation of the blowing agent is by a metal stearate compound.

Foamable PVC plastisol is applied onto the fabric using a knife-over-roll coater having a 26 mm application knife width. The gap between the knife and roller is approximately 2.5 mm, and is adjusted according to a coating speed of about 2.8 to about 3.5 meters per minute, which can also be adjusted according to the degree of foaming/expansion of the resulting PVC plastisol. The PVC plastisol paste is fed onto the fabric upstream of the coater from above by gravity from a storage vessel (drum or tote) through a hose or pipe. Containing the coating in a trough instead of an open rolling bank on the fabric prevents surface irregularities such as lines and bubbles.

The coated fabric enters a 15 meter long hot-air impingement oven with tenter-frame. As line speed is about 2.8 to about 3.5 meters per minute, the fabric is in the oven for about 4.29 to about 5.36 minutes. Oven temperature set point is a reverse-ramp configuration in five zones, wherein Zone 1 is about 200° C., Zone 2 is about 200° C., Zone 3 is about 190° C., Zone 4 is about 180° C., and Zone 5 is about 170° C. Air fans in the first two zones are run on high speed. Air fans in the last three zones are on low speed. Air control dampers are fully open on the bottom, fabric side, and on top of Zone 1, but progressively more restrictive on top in subsequent zones. The air temperature and flow settings are used in order to apply most of the heat from the bottom, and more heat earlier in the process. This results in the tightest, and most uniform foam cell structure, which is likely due to a rise in coating viscosity, caused by the heat, before the blowing agent begins to produce gas. The rise in coating viscosity prevents large and irregular foam cells by preventing cell-wall film breakage.

The fabric side of the hot, cured, but still molten material contacts a 0.7 meter cooling roller approximately three meters after the oven outlet. The top PVC foam side then contacts a second cooling roller of the same size. It is necessary to keep the tension in this section of the production machine as low as possible to prevent crushing the still molten foam, until it leaves the second cooling roller. Contact with the second cooling roller may also emboss the surface smooth. After cooling, the foam-coated fabric is rolled up and transferred back to the coater for the next production step.

The thickness of the foam-coated fabric is about 11 mm to about 13 mm. The weight of the foam-coated fabric is about 2.7 kg.m2 to about 2.9 kg/m2.

A solvent-based polyurethane adhesive is then applied to the fabric side of the PVC foam coated fabric layer. The adhesive comprises 22.5 weight % of polyurethane in mixed ketone solvents and has a Brookfield viscosity @20 rpm of approximately 5,000. A suitable polyurethane adhesive is available from Slocum Adhesives Corp, of Lynchburg, Va. A water-based adhesive can also be used.

A knife-over-gap coater with 2 mm application knife width is used to apply the polyurethane adhesive. Coating speed is about 4 meters per minute, after which the polyurethane is heated in an oven in which all zones are at a temperature of about 120° C. Air impingement fans are set on low speed, and air dampers open progressively from zone 1 to 5, both top and bottom. No bonding agent is used in the solvent based adhesive, in order to keep the peel strength between 0.5 and 1.0 Newtons per millimeter of belt width. This allows hand-peeling the panel plies apart when necessary to make a seam to increase the width of the panel material.

Two plies of foam-coated fabric are then laminated together on their fabric sides with a thermoplastic polyurethane elastomer using an extruder/calender. A suitable polyurethane is available from Lubrizol Corporation, having Shore hardness 85A, melt flow at 190° C., 8.7 kg is 45 to 65 grams/10 min.

In this step, hot molten thermoplastic polyurethane is supplied to a four-roll melt calendar by an extruder. The calendar roll temperatures are approximately Roller 1=140° C., Roller 2=150° C., Roller 3=155° C. and Roller 4=165° C. The melt calendar forms a film having an approximate thickness of 1 mm on a calendar roll, which is applied between two layers of foam-coated fabric that in the previous step were coated with the polyurethane adhesive. After lamination, the rough edges are trimmed off of the panel material, which is then rolled up and stored for fabrication.

The final step in fabrication of the insulated door panel is forming the door panel material to the appropriate size. If necessary, a seam must be made to make the material wide enough for a particular application. A specially-made hand tool with a vertical knife, and an edge guide is used to cut through the PVC foam and one of the fabric layers, into the polyurethane middle layer along the edge of two pieces of panel material. Then a strip of PVC foam and fabric is hand-peeled away from the corresponding edges of the two pieces of door panel material. The two pieces are joined together using a solvent based polyurethane adhesive. If desired, the middle layer can also be peeled from one of the panel edges in order that the thickness of the finished door panel in the seam area is the same as the rest of the door panel.

The foam insulating material forms an integral structure with the fabric carcass. Overall thickness of the resulting door panel is about 23 to about 27 mm (about 0.91″ to about 1.06″). The weight of the door panel does not exceed about 1.45 pounds per square foot.

It is understood that the scope of the door panel is not intended to be limited by the materials listed here, but may be carried out using any material which allows the construction and operation of the door panel described herein. For example, as an alternative to the insulating layer material described, any one of many elastomeric materials is suitable provided that it has suitable insulating properties and is capable of adhering to the fabric carcass. Such insulating layers may include, but are not limited to, a flexible open- or closed-cell foamed material of a chemically or physically cross-linked type. Polyurethane foam could also be used. A closed skin is advantageous. Materials of foamed polyolefins of a temperature stability down to at least −35° C., preferably −40° C., and a K-value of <2.5 are particularly suitable.

As shown in FIG. 2, the entire structure of the door panel 10 is in effect a single sheet and, while having sufficient lateral stiffness to form an effective closure, is sufficiently flexible longitudinally for the door panel to be unrolled and rolled on a 5-inch shaft or mandrel. The door panel 10 maintains this flexibility even at low temperatures. The foamed plastic material on each side of the door panel 10 minimizes heat exchange through door panel, resulting in good heat and cold insulation. In use, the door panel 10 presents an unbroken exterior surface. The inner surface of the door also presents a clear, unbroken surface to the inner portions of the refrigerated compartment. The arrangement described is highly durable, the insulation is unaffected by repeated rolling and unrolling cycles of the shutter equivalent to a lengthy operating life.

The door panel 10 described herein exhibits excellent thermal insulation properties, which limits thermal transfer so that zones with substantially different ambient temperatures can be separated from one another with the door panel. When used in an opening for commercial refrigerator or freezer, the door panel 10 minimizes the formation of condensation water on the warm side, and thus the formation of ice on and under the door panel. It is understood that the external temperature and the humidity on the outside, the inside temperature and eventually the inside humidity can be used as parameters for calculating the point at which condensation will be most extensively avoided. A further advantage is that the door panel 10 can be maintained energy free, that is, no heating is needed to prevent icing of the door panel.

The door panel 10 described herein is particularly, but not exclusively, for use as a vertically opening roll-up door as used for climate-controlled rooms, especially freezers. The door panel 10 can be used as well at factories, workshops, commercial garages and the like, for closing of large wall openings. It is contemplated that the door panel 10 may have other application, such as forming of roller shutters serving as closures or screens such as for use with processing or storage chambers or possibly on vehicles, boats or transport containers.

Although the present invention has been shown and described in considerable detail with respect to particular exemplary embodiments thereof, it should be understood by those skilled in the art that I do not intend to limit the invention to the embodiments since various modifications, omissions and additions may be made to the disclosed embodiments without materially departing from the novel teachings and advantages of the invention, particularly in light of the foregoing teachings. Accordingly, I intend to cover all such modifications, omission, additions and equivalents as may be included within the spirit and scope of the invention as defined by the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

I claim:

1. A door panel, comprising:
a fabric carcass, including
a first fabric layer having an inner surface and an outer surface,
a second fabric layer having an inner surface and an outer surface, and
a composition comprising polyurethane, the composition disposed between the inner surface of the first fabric layer and the inner surface of the second fabric layer for joining the first fabric layer and the second fabric layer;
a first foam polymeric layer having an inner surface and an outer surface, the inner surface of the first foam polymeric layer adhered to the outer surface of the first fabric layer such that the outer surface of the first foam polymeric layer at least partially forms an outer surface of the door panel; and
a second foam polymeric layer having an inner surface and an outer surface, the inner surface of the second foam polymeric layer adhered to the outer surface of the second fabric layer such that the outer surface of the second foam polymeric layer at least partially forms an inner surface of the door panel.

2. A door panel as recited in claim 1, wherein the first and second fabric layers are a woven polyester fabric.

3. A door panel as recited in claim 2, wherein the woven polyester fabric is a plain weave.

4. A door panel as recited in claim 2, wherein the warp yarns comprise a multifilament polyester yarn.

5. A door panel as recited in claim 4, wherein the multifilament polyester yarn is between about 500 and about 2000 denier.

6. A door panel as recited in claim 2, wherein the fabric comprises about 13 warp ends per centimeter in a lateral direction, and about 9 weft ends per inch in a longitudinal direction.

7. A door panel as recited in claim 2, wherein the weft yarns comprise a monofilament polyester weft yarn.

8. A door panel as recited in claim 7, wherein the monofilament polyester yarn is between about 0.3 mm. and about 0.5 mm in diameter.

9. A door panel as recited in claim 1, wherein the thickness of the fabric carcass is between about 11 mm. and about 13 mm.

10. A door panel as recited in claim 1, wherein the weight of the fabric carcass is between about 2.7 kg/m2 and about 2.9 kg/m2.

11. A door panel as recited in claim 1, wherein the thickness of the door panel is between about 23 mm. and about 27 mm.

12. A door panel as recited in claim 1, wherein the weight of the door panel is less than about 1.45 lb/ft2.

13. A door for mounting across an opening in a building wall, the door comprising:
a shaft adapted to be rotatably mounted to the wall substantially horizontally above door opening;
a door panel, comprising
a fabric carcass, including
a first fabric layer having an inner surface and an outer surface,
a second fabric layer having an inner surface and an outer surface, and
a composition comprising polyurethane, the composition disposed between the inner surface of the first fabric layer and the inner surface of the second fabric layer for joining the first fabric layer and the second fabric layer,
a first foam polymeric layer having an inner surface and an outer surface, the inner surface of the first foam polymeric layer adhered to the outer surface of the first fabric layer such that the outer surface of the first foam polymeric layer at least partially forms an outer surface of the door panel, and
a second foam polymeric layer having an inner surface and an outer surface, the inner surface of the second foam polymeric layer adhered to the outer surface of the second fabric layer such that the outer surface of the second foam polymeric layer at least partially forms an inner surface of the door panel; and
opposed track members adapted to be mounted to the wall adjacent the door opening for slidably receiving the side edges of the door panel,
wherein rotation of the shaft in one direction moves the door panel from a coiled condition in an open position to a closed position, and rotation of the shaft in the other direction winds the door panel around the shaft to the coiled condition for moving the door panel from the closed position to an open position.

14. A door as recited in claim 13, further comprising an electromechanical means for rotating the shaft.

15. A door as recited in claim 14, wherein the electromechanical means comprises an electric motor operatively connected to shaft for rotating the shaft.

16. A door panel as recited in claim 13, wherein the first and second fabric layers are a woven polyester fabric.

17. A door panel as recited in claim 16, wherein the woven polyester fabric is a plain weave.

18. A door panel as recited in claim 16, wherein the warp yarns comprise a multifilament polyester yarn.

19. A door panel as recited in claim 18, wherein the multifilament polyester yarn is between about 500 and about 2000 denier.

20. A door panel as recited in claim 16, wherein the fabric comprises about 13 warp ends per centimeter in a lateral direction, and about 9 weft ends per inch in a longitudinal direction.

21. A door panel as recited in claim 16, wherein the weft yarns comprise a monofilament polyester weft yarn.

22. A door panel as recited in claim 21, wherein the monofilament polyester yarn is between about 0.3 mm. and about 0.5 mm in diameter.

23. A door panel as recited in claim 13, wherein the thickness of the fabric carcass is between about 11 mm. and about 13 mm.

24. A door panel as recited in claim 13, wherein the weight of the fabric carcass is between about 2.7 kg/m2 and about 2.9 kg/m2.

25. A door panel as recited in claim 13, wherein the thickness of the door panel is between about 23 mm. and about 27 mm.

26. A door panel as recited in claim 13, wherein the weight of the door panel is less than about 1.45 lb/ft2.
